(19) United States
(12) Patent Application Publication
(10) Pub. No.: US 2006/0268411 A1
(43) Pub. Date: Nov. 30, 2006

(54) Optical scanning apparatus and image forming apparatus employing the same

(75) Inventors: Min-gyu Kim, Seoul (KR); Jae-hwan Yoo, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/441,048

(22) Filed: May 26, 2006

(30) Foreign Application Priority Data
May 27, 2005 (KR) 10-2005-0045206

(51) Int. Cl. G02B 5/18; G02B 27/44

(52) U.S. Cl. 359/566

(57) ABSTRACT

An optical scanning apparatus includes a light source that emits light. A diffraction device diffracts light emitted from the light source to image the light onto an image forming surface in accordance with image information. A diffraction controller sends diffraction information to the diffraction device to form a diffraction grating image on the diffraction device in a predetermined pattern to image the light in accordance with the image information. The optical scanning apparatus is used by an image forming apparatus.

### CROSS-REFERENCE TO RELATED PATENT APPLICATION

This application claims the benefit under 35 U.S.C. § 119(a) of Korean Patent Application No. 10-2005-0045206, filed on May 27, 2005, in the Korean Intellectual Property Office, the entire disclosure of which is hereby incorporated by reference.

### BACKGROUND OF THE INVENTION

1. Field of the Invention

The present invention relates to an optical scanning apparatus and an image forming apparatus employing the same. More particularly, the present invention relates to an optical scanning apparatus and an image forming apparatus employing the same in which the optical scanning apparatus does not include a spindle motor.

2. Description of the Related Art

Optical scanning apparatuses, such as laser scanning units (LSUs), are used for image forming apparatuses, such as copying machines, printers, and facsimiles. In an optical scanning apparatus, a light source, such as a laser diode, emits a light beam corresponding to a video signal, and the light beam is projected to a photoconductor of an image forming apparatus to form an electrostatic latent image on the photoconductor. The electrostatic latent image is developed into a visible toner image and then transferred to a printing medium to form an image.

FIG. 1 shows an optical structure of a conventional optical scanning apparatus.

Referring to FIG. 1, a conventional optical scanning apparatus includes a laser diode 2 that emits a laser beam according to an image signal. A polygonal mirror 5 rotates to reflect the laser beam in a horizontal direction at a constant linear velocity. An f-θ lens 9 directs the light scanned by the polygonal mirror 5 toward a photoconductive drum 160.

The laser diode 2 is controlled by an auto power controller (APC) 6 so that light power is maintained uniformly. The polygonal mirror 5 is rotated at a constant speed by a spindle motor 7 under the control of a motor controller 8.

The optical scanning apparatus further includes a cylinder lens 4 to direct a laser beam emitted from the laser diode 2 linearly onto a mirror surface of the polygonal mirror 5 in a horizontal direction. The optical scanning apparatus includes a collimator lens 3 to make a laser beam emitted from the laser diode 2 parallel or converged with respect to an optical axis.

During the image forming operation, the spindle motor 7 rotates the polygonal mirror 5 having a plurality of mirror surfaces at a constant speed in a specific direction. The polygonal mirror 5 reflects a laser beam emitted from the laser diode 2 in a horizontal direction (main scanning direction) at a constant linear speed.

The f-θ lens 9 deflects the constant speed light beam reflected from the reflective surface of the polygonal mirror 5 to the main scanning direction, compensates aberrations of the light beam, and focuses the light beam on the scanning surface of the photoconductor, such as the photoconductive drum 160. The f-θ lens 9 forms an image of the light beam reflected from the mirror surface of the polygonal mirror 5 and scans defectively with different magnification power in a main scanning direction and a sub scanning direction.

The optical scanning apparatus further includes a photo sensor 15 for detection of a synchronization signal to fit horizontal synchronization by receiving a portion of the laser beam reflected from the mirror surface of the polygonal mirror 5. A reflection mirror 11 reflects the laser beam toward the photo sensor 15. Furthermore, the optical scanning apparatus further includes a reflection mirror 10 that reflects scanning light beam passing through the f-θ lens 9 so that the light beam is focused as a point image onto the surface of the photoconductive drum 160 as an image forming plane to form an electrostatic latent image thereon.

The optical scanning apparatus depicted in FIG. 1 turns on and off the laser diode 2 to form a single scanning line according to a one-bit scanning method. Thus, this type of optical scanning apparatus can be called a single-beam optical scanning apparatus.

Meanwhile, in a high-speed optical scanning apparatus, a plurality of laser beams are simultaneously projected to form a plurality of scanning lines at a time. Such an optical scanning apparatus is called a multi-beam optical scanning apparatus.

FIG. 2 shows an example of a conventional multi-beam optical scanning apparatus with two multi-beam laser diodes 21 and 25 of single CAN-type to form multi-scanning lines during single scanning by generating multi-beams. FIG. 2 shows an example that four scanning lines are formed during single scanning by reflecting light beams emitted from two multi-beam laser diodes 21 and 25, each laser diode being capable of emitting two laser beams from the mirror surface of a single polygonal mirror 30. Referring to FIG. 2, laser beams emitted from the multi-beam laser diodes 21 and 25 are simultaneously deflected by the mirror surface of the polygon mirror 30 so that a plurality of light spots are formed on a scanned plane (the surface of a photoconductor) thereby scanning a plurality of printing lines simultaneously.

Reference numerals 22 and 26 denote collimating lenses. Reference numerals 23 and 27 denote cylinder lenses. Reference numerals 24, 25, 28, and 29 denote mirrors.

The above-described laser diodes 21 and 25 result in a distance between a plurality of beam spots on a scanned plane. However, since the distance between the laser diodes 21 and 25 is much larger than the required distance between the beam spots, the conventional multi-beam optical scanning apparatus as shown FIG. 2 uses beam combining means in addition to the lenses (22 and 23) and (26 and 27) to combine beams passing through each of the lenses (22 and 23) and (26 and 27), and emits the beams with a constant distance or angle.

Since the above-described single-beam or multi-beam optical scanning apparatus uses the spindle motor to rotate the polygonal mirror, problems such as jitter and repeatable run out (RRO) are created. Furthermore, the performance of a mechanical element, such as the spindle motor, decreases according to frequency of use.

Furthermore, the laser beams pass through the plurality of optical components, thereby increasing power consumption. Also, for scanning multi-beams for high-speed, a plurality of laser diodes must be used. Additionally, the size of the optical scanning apparatus increases due to usage of the plurality of laser diodes.

Accordingly, a need exists for an optical scanning apparatus having an improved image forming apparatus that operates without a spindle motor, thereby substantially eliminating problems associated with operation of the spindle motor.

### SUMMARY OF THE INVENTION

Embodiments of the present invention provides an optical scanning apparatus and image forming apparatus employing the same that substantially eliminate jitter and repeatable run out problems by removing a spindle motor.

According to an aspect of the present invention, an optical scanning apparatus includes a light source to emit light, a diffraction device to diffract the light emitted from the light source to image the light onto an image forming surface in accordance with image information, and a diffraction controller to send diffraction information to the diffraction device to form a diffraction grating image on the diffraction device in a predetermined pattern to image the light in accordance with the image information.

The optical scanning apparatus may further include an optical unit to shape the light from the light source in a predetermined form and to direct the shaped light to the diffraction device.

The diffraction device may be a liquid crystal display panel capable of forming a diffraction grating image thereon according to a diffraction information signal from the diffraction controller.

The light source may include a laser diode or a light-emitting diode.

The diffraction grating image may be a computer generated holography (CGH) image.

The diffraction controller may include a database or a CGH generator to produce the CGH image.

The diffraction device may be formed to scan one or more scanning lines on the image forming surface at a time under a control of the diffraction controller.

According to another aspect of the present invention, an image forming apparatus includes a photoconductor, and an optical scanning apparatus to scan the photoconductor with light to form an electrostatic latent image on the photoconductor. The optical scanning apparatus includes at least one characteristic described above.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 shows an optical structure of a conventional optical scanning apparatus;

FIG. 2 is a schematic view of an example of a conventional multi-beam optical scanning apparatus;

FIG. 3 is a schematic view of an overall structure of an optical scanning apparatus according to an exemplary embodiment of the present invention; and

FIG. 4 shows various examples of data transferred on an image forming surface of a photoconductive drum of FIG. 3.

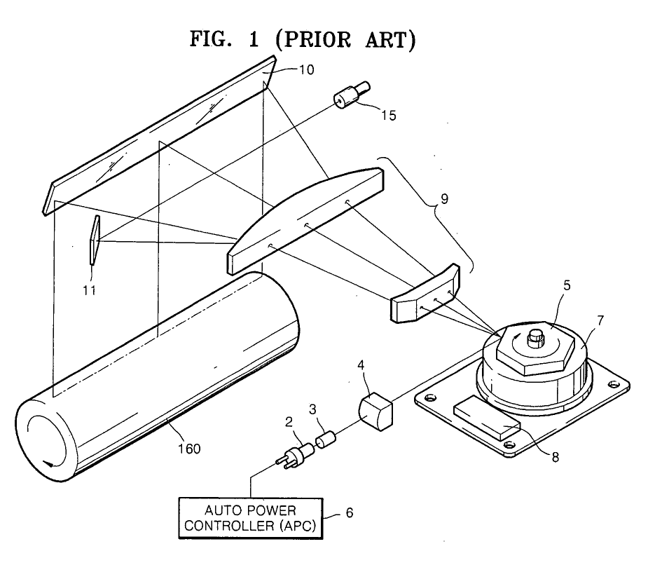

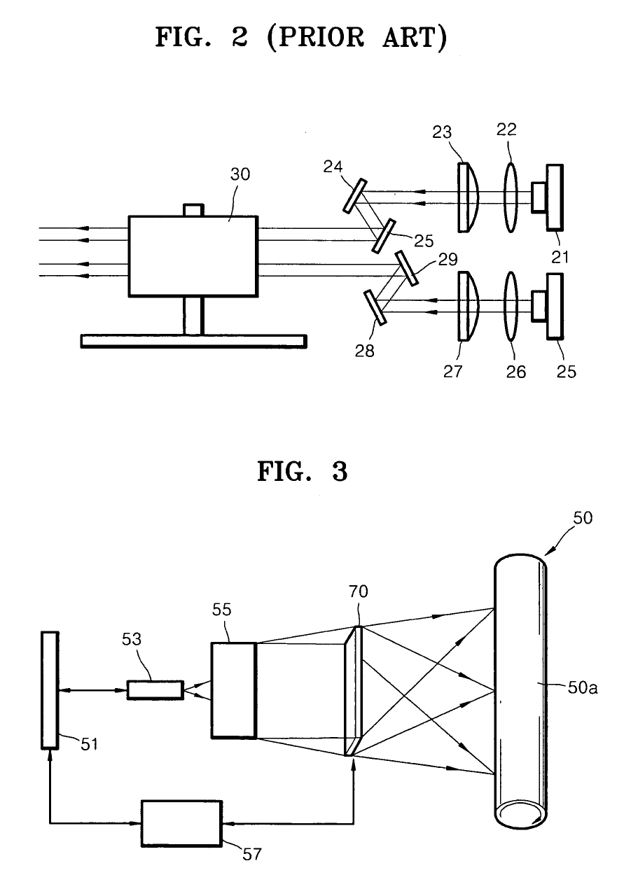

Throughout the drawings, like reference numerals will be understood to refer to like parts, components and structures.

### DETAILED DESCRIPTION OF EXEMPLARY EMBODIMENTS

The exemplary embodiments of the present invention are described more fully below with reference to the accompanying drawings.

FIG. 3 is a schematic view of an overall structure of an optical scanning apparatus according to an exemplary embodiment of the present invention.

Referring to FIG. 3, an optical scanning apparatus of an exemplary embodiment of the present invention includes a light source 53 that emits light, a diffraction device, and a diffraction controller 57. The diffraction device diffracts the light emitted from the light source 53 so that the diffracted light is focused on a scanned surface, such as an image forming surface 50a of a photoconductive drum 50, to correspond to an image signal. The diffraction controller 57 controls the diffraction device to diffract the light according to image information regarding the image to be formed.

The optical scanning apparatus includes an optical unit 55 that shapes the light emitted from the light source 53 in a predetermined form before the diffraction device. The optical scanning apparatus is controlled by a main controller 51. The main controller 51 controls the light source 53 and the diffraction device, such as a liquid crystal display panel 70.

The light source 53 may include a semiconductor laser diode (LD) or a light emitting diode (LED).

The optical unit 55 shapes the light emitted from the light source 53 to a specific form, such as a parallel form. The light source 53 emits diverging light having a strong intensity at a center and a lower intensity away from the center. For example, the light emitted from the light source 53 may have a Gaussian distribution.

The optical unit 55 may collimate the light emitted from the light source 53 to be substantially parallel light and to have a substantially uniform distribution. The optical unit 55 may be formed to shape the cross sectional area of the light according to the size of the diffraction device.

For example, the optical unit 55 may include at least two lenses for the collimation. It is well known to those of ordinary skill in the optics art that light may be magnified and converted from Gaussian distribution to uniform distribution (parallel light) by using a combination of at least two lenses. The light shaped by the optical unit 55 is directed to the diffraction device.

The diffraction device is located on the path of the light shaped by the optical unit 55. The diffraction device receives the shaped light from the optical unit 55 and diffracts it toward an imaging surface, such as the surface 50 of the photoconductive drum 50, to form an image corresponding to image information.

The diffraction controller 57 controls the diffraction device such that the diffraction controller 57 gives diffraction information to the diffraction device to form a diffraction grating image with a specific pattern, thereby making a light image corresponding to the image information.

The diffraction device may be the liquid crystal display panel 70 that forms a diffraction grating image thereon according to the diffraction information signal received from the diffraction controller 70.

As is well known to those of ordinary skill in the display art, the liquid crystal display panel 70 includes a plurality of pixels that are arrayed in two dimensions. Each pixel may be individually operated between on and off states. The pixels of the liquid crystal display panel 70 are turned on or off according to the control of the diffraction controller 70. The pixel operated to allow light to pass therethrough functions as a slit. As is well known, light passing through a slit is diffracted and thus at least one discontinuous light spot is formed.

That is, a desired diffraction grating image may be formed on the liquid crystal display panel 70 by turning on and off the pixels of the liquid crystal display panel 70 in a predetermined pattern under the control of the diffraction controller 57. As the light passes through the liquid crystal display panel 70 where the diffraction grating image is formed, the light is diffracted to form light spots corresponding to image information to be printed on the imaging surface. In this way, an electrostatic latent image corresponding to image information is formed at a position where the light spots are formed when the photoconductor, such as the photoconductive drum 50, is located at the imaging surface. In an image forming apparatus, such as a printer, employing the optical scanning apparatus according to an exemplary embodiment of the present invention, the electrostatic latent image is developed into a toner image by a development unit (not shown), and then printed. The image forming apparatus includes the optical scanning apparatus for scanning a light beam, and a photoconductor, such as the photoconductive drum 50.

The diffraction grating image formed in the diffraction device may be a computer generated holography (CGH) image. For this, the diffraction controller 57 may include a database having data of a CGH image itself corresponding to image information to be formed, or it may include a CGH generator capable of creating a CGH image corresponding to the image information to be formed. Since the electrostatic latent image can be formed in units of at least one dot on the imaging surface, the CGH generator may be made in ASIC type to store a dot related database.

The liquid crystal display panel 70 may be formed with the diffraction grating image for scanning one or more lines at a time. Therefore, the diffraction controller 57 may be designed to control the diffraction device for one line or multiple line scanning.

The CGH means composite CGH data that has at least one bit. For example, the CGH may include a data unit with a plurality of bits for scanning one line at a time.

As explained above, the diffraction device and the diffraction controller 57 are constructed such that the optical scanning apparatus may scan one or more lines at one time with the single light source 53.

Therefore, the time required for scanning one line is considerably decreased when compared to using a polygonal mirror according to the related art. Also, multiple lines may be scanned at one time with the single light source 53.

An operation of the optical scanning apparatus is described below.

First, the light source 53 is powered on under the control of the main controller 51 to emit light continuously. This continuous light, as it passes through the optical unit 55, is shaped into light, such as parallel light, and then the light is directed to the diffraction device.

The main controller 51 controls the diffraction controller 57, such as the CGH generator, to display diffraction grating information corresponding to one line of image information on the diffraction device, such as the liquid crystal display panel 70.

A diffraction grating image is displayed on the liquid crystal display panel 70 according to the diffraction grating information, and then the parallel light from the optical unit 55 passes through this diffraction grating to form a diffraction image corresponding to the image information. The diffraction image corresponding to the image information is projected to the photoconductor, such as the photoconductive drum 50.

This procedure is repeated in substantially the same way to scan each line, such that a scanning image is formed. During the repetition of the procedures, a CGH image (diffraction grating information) corresponding to each line of image information is formed on the liquid crystal display panel 70.

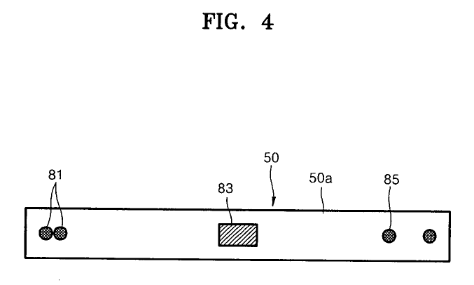

Referring to FIG. 4, a one-bit data 85 or multi-bit data 81 may be formed on the image forming surface 50a of the photoconductive drum 50 by using a single CGH image. A sized image 83 having a plurality of combined bits may be formed at a time by using a single CGH image. Furthermore, one line or multiple lines may be formed on the image forming surface 50a at one time.

As described above, the optical scanning apparatus of the present invention is operated using a new technology entirely different from the related art. The optical scanning apparatus forms desired image information on the image forming surface by projecting light onto the image forming surface through the diffraction device where a corresponding diffraction grating image, such as a CGH image is formed, such that the optical scanning apparatus may be made without a spindle motor. The optical scanning apparatus may be made without lenses, such as an f-θ lens, because light corresponding to the desired image information may be projected onto the image forming surface through the diffraction device. Therefore, problems such as jitter and repeatable run out (RRO) caused by the rotation of the spindle motor are substantially eliminated.

Furthermore, because one or more lines may be scanned at a time using only a single light source, a plurality of light sources or complex optical structure is not required to increase printing speed, thereby reducing the size of the optical scanning apparatus.

Though only one-bit information may be scanned at a time through on and off control of the light source according to the related art, multi-bit information may be scanned at a time in several ways such as simultaneous scanning of one or more lines according to exemplary embodiments of the present invention. Therefore, high-speed scanning may be attained. High-speed printing may be attained by scanning multi-bit data or variously combined data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical scanning apparatus, comprising:
a light source to emit light;
a diffraction device to diffract the light emitted from the light source to image the light onto an image forming surface in accordance with image information; and
a diffraction controller to send diffraction information to the diffraction device to form a diffraction grating image on the diffraction device in a predetermined pattern to image the light in accordance with the image information.

2. The optical scanning apparatus of claim 1, wherein
an optical unit shapes light from the light source in a predetermined form and directs the shaped light to the diffraction device.

3. The optical scanning apparatus of claim 2, wherein
the diffraction device is a liquid crystal display panel capable of forming a diffraction grating image thereon according to a diffraction information signal from the diffraction controller.

4. The optical scanning apparatus of claim 1, wherein
the diffraction device is a liquid crystal display panel capable of forming a diffraction grating image thereon according to a diffraction information signal from the diffraction controller.

5. The optical scanning apparatus of claim 1, wherein
the light source includes one of a laser diode and a light-emitting diode.

6. The optical scanning apparatus of claim 1, wherein
the diffraction grating image is a CGH (computer generated holography) image.

7. The optical scanning apparatus of claim 6, wherein
the diffraction controller includes a database or a CGH generator to produce the CGH image.

8. The optical scanning apparatus of claim 6, wherein
the diffraction controller controls the diffraction device to scan at least one scanning lines on the image forming surface at a time.

9. The optical scanning apparatus of claim 1, wherein
the diffraction controller controls the diffraction device to scan at least one scanning lines on the image forming surface at a time.

10. An image forming apparatus, comprising:
a photoconductor; and
an optical scanning apparatus to scan the photoconductor with light to form an electrostatic latent image on the photoconductor,
wherein the optical scanning apparatus includes
a light source to emit the light;
a diffraction device to diffract the light emitted from the light source to image the light onto an image forming surface of the photoconductor in accordance with image information; and
a diffraction controller to send diffraction information to the diffraction device to form a diffraction grating image on the diffraction device in a predetermined pattern to image the light in accordance with the image information.

11. The optical scanning apparatus of claim 10, wherein the optical scanning apparatus includes
an optical unit to shape the light from the light source in a predetermined form and to direct the shaped light to the diffraction device.

12. The optical scanning apparatus of claim 11, wherein
the diffraction device is a liquid crystal display panel capable of forming a diffraction grating image thereon according to a diffraction information signal from the diffraction controller.

13. The optical scanning apparatus of claim 10, wherein
the diffraction device is a liquid crystal display panel capable of forming a diffraction grating image thereon according to a diffraction information signal from the diffraction controller.

14. The optical scanning apparatus of claim 10, wherein
the light source includes one of a laser diode and a light-emitting diode.

15. The optical scanning apparatus of claim 10, wherein
the diffraction grating image is a CGH image.

16. The optical scanning apparatus of claim 15, wherein
the diffraction controller includes a database or a CGH generator to produce the CGH image.

17. The optical scanning apparatus of claim 15, wherein
the diffraction controller controls the diffraction device to scan at least one scanning lines on the image forming surface at a time.

18. The optical scanning apparatus of claim 10, wherein
the diffraction controller controls the diffraction device to scan at least one scanning lines on the image forming surface at a time.
